(19) United States
(12) Patent Application Publication
(10) Pub. No.: US 2018/0288610 A1
(43) Pub. Date: Oct. 4, 2018

(54) PRIVACY-PROTECTED ACTIVITY REPORTING

(71) Applicant: Intel Corporation, Santa Clara, CA (US)

(72) Inventors: Robert Lawson Vaughn, Portland, OR (US); Michael Kuperstein, Hillsboro, OR (US)

(21) Appl. No.: 15/475,520

(22) Filed: Mar. 31, 2017

(51) Int. Cl. H04W 12/02; H04W 4/12; H04W 4/02

(52) U.S. Cl. CPC H04W 12/02; H04W 4/028; H04W 4/12

(57) ABSTRACT

Activity of a subject is reported to an entity interested in the arrival of the subject at a destination. Context indicia relating to usage of the device is generated based on sensor data and content data of the device of the subject. The usage of the device includes travel to the destination. An estimated time of arrival (ETA) of the subject at the destination is determined based on the context indicia. An impact on the ETA of any changes in the context indicia is assessed. Content for a timeliness notification is generated based on a predefined degree of candor from among multiple degrees of candor regarding the timeliness of the ETA. Privacy criteria that defines a content limit to the timeliness notification, is applied. Any content of the timeliness notification that exceeds the content limit is removed to produce a minimally-informative notification to be communicated to the entity.

### TECHNICAL FIELD

Embodiments described herein generally relate to information processing and mobile computing and, more particularly, to the use of a special-purpose machine implemented on a computing device having a computational architecture that improves the computational efficiency and reliability for informing interested parties regarding a subject's movement or travel to a destination, while preserving the privacy of the subject and the subject's activity.

### BACKGROUND

Today's modern society is a world full of appointments and numerous reminder notifications. To many users of technology, notifications have lost their effectiveness. Users have reported becoming desensitized to the incessant cacophony of beeps and buzzes. A need exists for an improved way to coordinate the passing of pertinent arrival-related information to individuals having an interest in certain events, such as upcoming appointments or meetings, for example.

Moreover, users are increasingly and justifiably concerned about sharing, or providing access to, personal information such as a user's location or activity. A number of cloud-based services have been deployed that can provide useful activity monitoring and relevant notifications. However, they generally involve collecting personal information from users of mobile devices in order to perform their useful operations. Many users are oblivious at first about the extent of collection of personal information, only to be dismayed later upon learning about the extent of accessibility to personal information regarding their whereabouts that is granted to third parties to enable those operations.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings.

FIG. 1 is a block diagram illustrating some of the components of an example computing device according to an embodiment.

FIG. 2 is a block diagram illustrating an exemplary system architecture of a computing device such as the device of FIG. 1, according to an embodiment.

FIG. 3 is a diagram illustrating an exemplary hardware and software architecture of a computing device such as the one depicted in FIG. 2, in which various interfaces between hardware components and software components are shown.

FIG. 4 is a system block diagram illustrating a user location or movement-based alert system 400 according to an example embodiment.

FIG. 5A illustrates an example of an interested-party interface of the system of FIG. 4 according to an example.

FIG. 5B illustrates a sensor interface of the system of FIG. 4 according to an example.

FIG. 5C illustrates a device content interface according to an example.

FIG. 6 is a block diagram illustrating various components of a context assessor of the system of FIG. 4 according to an example embodiment.

FIG. 7 is a diagram illustrating an example machine-learning-based implementation of an event/circumstance impact assessor according to an illustrative embodiment.

FIG. 8 is a table listing an example set of levels of candor for notifications relating to destination-arrival scenarios consistent with various operational examples.

FIG. 9 is a diagram illustrating a minimum-information filter of the system of FIG. 4 according to an example embodiment.

FIG. 10 is a flow diagram illustrating an example of the operation of the system of FIG. 4 according to various embodiments.

### DETAILED DESCRIPTION

Some aspects of the embodiments are directed to a mobile computing device that is configurable as a special-purpose machine to efficiently detect movement and other activity of subjects, determine whether the subjects are expected at a destination, and generate and transmit automated notifications to other parties or entities that have an interest in information regarding the transit, or projected arrival, of those respective subjects at the respective destinations. In related aspects of the embodiments, the mobile computing device is configured to ensure that the notification does not divulge any personal or private details of the subject's movement, transit, mobile device usage, or other activity. In the present context, a subject may be a human user of the mobile computing device, or an autonomous device, such as a walking, driving, flying, or swimming robotic system.

A system implemented on a mobile device according to some examples may automatically determine whether there is a relationship between the mobile device and a second party's device (which may be a mobile device or accessory such as a smartwatch, smart glasses, etc., or an Internet of Things (IoT) device such as an appliance, automobile, or other machine). These two devices may establish a proximal contextual relationship in which some level of trust is established. The trust relationship may be of a peer-to-peer nature so that it is not orchestrated and trackable by a third party.

Thus, in some examples, an operational scenario involves two devices that are known to each other. In another operational scenario, trust may be established through another suitable mechanism such as having a prior relationship with a doctor, resulting in trusting the corresponding doctor's office scheduling system.

The system according to some examples is configured to identify patterns of movement of the subject. Contextual cues (e.g., attributes) reinforce identified trends, such as recognizable and repeated routes. For instance, through a machine learning process based on subject-specific history, the system may compile a set of regular destinations to which the subject has demonstrated patterns of travel.

In a related example, the system may determine or obtain information regarding the usage context of a device belonging to a person or entity at the destination of the subject, or other device having a trust relationship with the subject's device. For instance, the system may determine from contextual information that the subject's spouse may travel to the destination in lieu of the subject.

In related examples, the system estimates the time of arrival (ETA) of the subject to the destination, and re-computes the ETA in response to events or circumstances impacting the prior ETA computation. Notably, in some embodiments, ETA calculations are performed based on learned effects of events by way of machine-learning algorithms.

As an example, a process that may be implemented on a mobile device includes the following operations: (i) a scheduled event is made known to the system; (ii) the subject is monitored as she travels to the scheduled event's destination; (iii) route analysis is performed using an analysis engine to produce an initial ETA; (iv) observation of the subject's motion and other activity continues throughout the subject's travel time, and any stopovers and circumstances that vary from the considerations used for the route analysis trigger the analysis engine to re-compute the ETA; (v) for each stopover, a duration of visit is logged along with the stopover location; (vi) the stopover location may be further analyzed to assess the type of location; (vii) the analysis engine is updated by way of machine-learning processes to reflect the duration-of-visit and other observed effects on the ETA computation, so that these parameters may be taken into account for future ETA computations; and (viii) a notification is generated to inform the interested party or entity about the ETA, or to inform the interested party or entity about the probability of the subject's arrival at the scheduled time.

Notably, the ETA computation, and the information upon which the ETA computation is based, are maintained in strict confidence on the subject's mobile computing device, or on a trusted protected network of devices. For instance, cloud-based mapping, weather, traffic, and business-listing services may be used, but no information about the subject's identity, location, or route is shared with a third-party cloud-based service unless specifically authorized by the subject.

In a related embodiment, the automated notification is filtered according to predefined privacy-protection rules to ensure that the recipient(s) of the notification are prevented from accessing personal or private information of the subject. Notably, in some examples, various levels of privacy-protection filtering may be applied for various recipients of ETA or ETA-based notification.

While aspects of the embodiments may be described herein in the context of determining activities and motion of a human user, it should be understood that similar principles are applicable to autonomous systems such as autonomous vehicles such as self-driving passenger cars, taxis, delivery vehicles, autonomous aerial drones, autonomous water craft, or the like, where there is an element of uncertainty relating to arrival time, and also a need for privacy of location information.

According to various embodiments, a wide variety of computing devices are contemplated, such as mobile computing devices (e.g., smartphones, tablets, laptops, virtual/augmented reality head-mounted devices, smart glasses, smart watches, ear- or head-mounted audio players, and the like). A computing device may have a variety of integrated data capture devices, or may be interfaced with a distinctly-housed data capture device.

Computing devices according to various embodiments may be configured to monitor their respective environments for specific actions, such as movement and location changes, as well as one or more cues based on usage of the device to send, receive, or process pertinent information. For ease of discussion, some examples below are described in the context of motion, such as travel toward or away from a stated or inferred destination, and stops along the way at known locations, for instance. It will be appreciated by persons having skill in the relevant arts that similar principles may be applicable for other types of events.

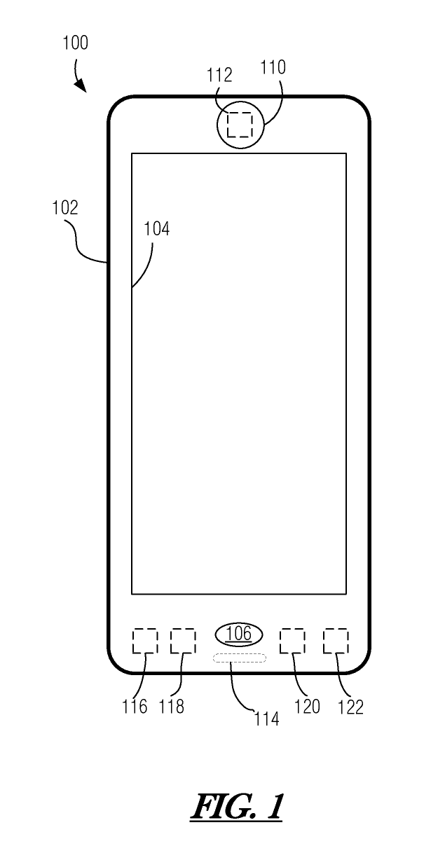

FIG. 1 is a block diagram illustrating some of the components of an example computing device 100 according to an embodiment. Computing device 100 is illustrated as a smartphone in this example, through it will be understood that computing device 100 is representative of other types of computing devices, which may have more or fewer data capture devices or other features than exemplary computing device 100. Computing device 100 has a housing 102 that encloses the interior components.

Computing device 100 further includes one or more display screens 104 which may form a part of the overall enclosure of device 100 in cooperation with housing 102. Display 104 includes hardware that functions as an output device (e.g., an organic light-emitting diode (OLED) screen for visual display, power and controller circuitry, etc.). In a related embodiment, display 104 includes a touchscreen input device generally layered over (or under) the visual display and formed from a suitable touch or proximity-sensitive technology (e.g., capacitive, resistive, optical, ultrasonic, etc.), along with the corresponding detection and power circuitry.

Additionally, computing device 100 includes user input device 106, which in this example represents one or more human-computer interaction devices, such as button(s), keypad, keyboard, trackpad, mouse, etc.

As further depicted in FIG. 1, computing device 100 has several data capture devices, such as sensing transducers, the physical stimulation of which produces signaling that may be sampled, digitized, and stored as captured data. Camera 110 includes an image sensor 112, along with additional hardware for digitizing, processing, and storing portions of the image sensor 112 output. Camera 110 also includes optics that may form a portion of housing 102. Camera 110 may record still images, motion video, or both.

Microphone 114 includes audio capture circuitry that samples, digitizes, and stores portions of the signaling produced by microphone 114 in response to sensed acoustic stimulus. Microphone 114 is typically activated together with camera 110 when data capture device 100 is operated to record videos.

Global positioning system (GPS) receiver 116 includes an antenna and radio receiver circuitry to receive multiple signals being broadcast by a constellation of Earth-orbiting satellites, along with processing circuitry to discern the current position on the Earth of data computing device 100. Accelerometer 118 includes a multi-axis sensor that produces signaling in response to changes in motion, and electronics to sample and digitize that signaling. Magnetometer 120 includes sensors and supporting circuitry that detect the direction and intensity of the ambient magnetic field, or any externally-applied magnetic fields. Biometric sensor 122 includes an array of sensors for measuring a biometric indicator, such as a user's fingerprint, along with supporting circuitry.

Location may also be determined using signal propagation timing (e.g., time-of-flight analysis) between computing device 100 and one or more base station devices such as a wireless local area network (WLAN) access point, evolved node-B (eNB), or the like, using a location-determining protocol such as, for instance, as specified in the developments of IEEE 802.11az specifications.

The various data capture devices, whether individually, or in combination with one or more other data capture devices, may obtain information from which computing device 100 may discern facts about its operational state(s) or surrounding environment. For example, accelerometer 118 and magnetometer 120 may be used in combination to determine the orientation of computing device 100 with greater accuracy than either of these data capture devices alone.

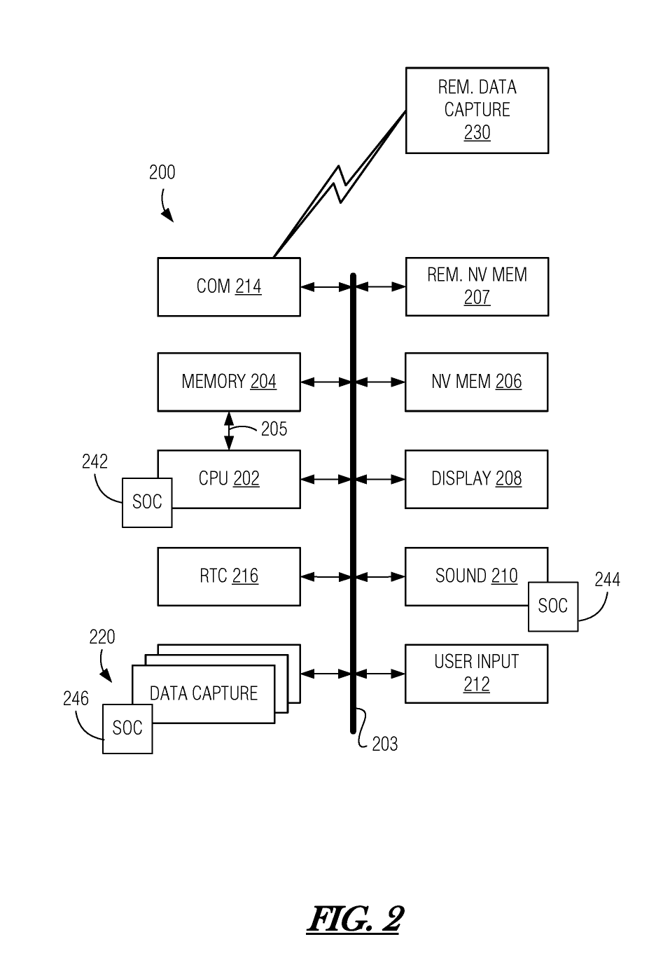

FIG. 2 is a block diagram illustrating an exemplary system architecture 200 of computing device 100 according to an embodiment. Central processing unit (CPU) 202 includes one or more microprocessors on which the overall functionality of computing device 100 is executed. CPU 202 is formed from hardware that is electrically interfaced with system link 203, which carries data and control signaling between the various components. As illustrated, system link 203 is similarly interfaced with each of the other components of system architecture 200. Memory 204 includes working memory space, and is constructed from suitable high-speed memory devices such as synchronous dynamic random access memory (SDRAM). In the embodiment illustrated, CPU 202 may access memory 204 using high-speed interface 205. Non-volatile memory 206 is constructed using read-only memory (ROM), electrically-erasable programmable read-only memory (EEPROM), flash memory or other suitable non-volatile storage technology. Non-volatile memory 206 stores system and application software that is executed by CPU 202 and, in some cases, by processors present in one or more other components.

Removable non-volatile memory 207 includes an interface such as a secure digital (SD) card slot, which may accept removable storage media to be used as additional non-volatile data storage.

Display 208 includes display 104 and circuitry for interfacing the display 104 with the system, as well as video driving circuitry. Sound 210 contains circuitry for driving the audio output to a speaker or headphones, and the circuitry for interfacing with the system. User input 212 contains the circuitry for interfacing with input devices such as input device 106. Communications block 214 represents communications circuitry and circuitry for interfacing the communications circuitry with the system. Communications block 214 may include a radio for communicating over a cellular network such as a network designed according to the Long-Term Evolution (LTE), LTE-Advanced, 5G or Global System for Mobile Communications (GSM) families of standards. Also, communications circuitry 214 may include a Wi-Fi communications radio according to the IEEE 801.11 family of standards, or a Bluetooth radio circuit according to the IEEE 802.15 family of standards. Real-time clock 216 includes circuitry that provides a clock that maintains the current date and time, and that interfaces the clock to the system.

Data capture devices 220 are integrated with computing device 200. According to various embodiments, data capture devices 220 include a plurality of different types of sensing transducers and their associated processing and interface circuitry, such as a camera, GPS, accelerometer, and biometric sensor.

In the case of a camera, the transducer may be an image sensor device, such as a charge-coupled device (CCD) array or a complementary metal-oxide semiconductor (CMOS)-based sensor. In the case of a GPS, the transducer is one or more GPS signal-receiving antennas. In the case of an accelerometer, the transducer may be a micro electro-mechanical system (MEMS)-based device utilizing capacitive, piezoelectric, or other suitable technology to produce electrical signaling. In the case of a biometric sensor, the transducer may be any suitable optical, capacitive, ultrasonic, chemical, or other sensor. It will be understood that these examples are provided herein for illustration and context, and are not meant to be limiting unless expressly enumerated in a particular claim.

The processing circuitry associated with each corresponding transducer may include amplification, buffering, filtering, or other signal-conditioning circuitry to receive the raw analog signal from the corresponding transducer and prepare the analog signaling for digitization, analog-to-digital conversion circuitry to perform sampling, quantization, and digital encoding, and, in some cases, further processing to produce a digital signal representing the physical phenomenon being measured by the transducer in a form that is readable by CPU 202.

Remote data capture device 230 is interfaced with CPU 202 via communication block 214, as depicted. Remote data capture device 230 may be any type of data capture device described above, or may be a different type of data capture device altogether.

In a related type of embodiment, system architecture 200 includes one or more systems on chips (SoCs) 242, 244, 246. One or more of the SoCs may be incorporated as part of CPU 202, sound 210, and one or more of data capture devices 220 as depicted. SoCs 242-246 may include analog, mixed-signal, and digital circuitry, including signal conditioning, A/D, D/A. memory and data-processing portions.

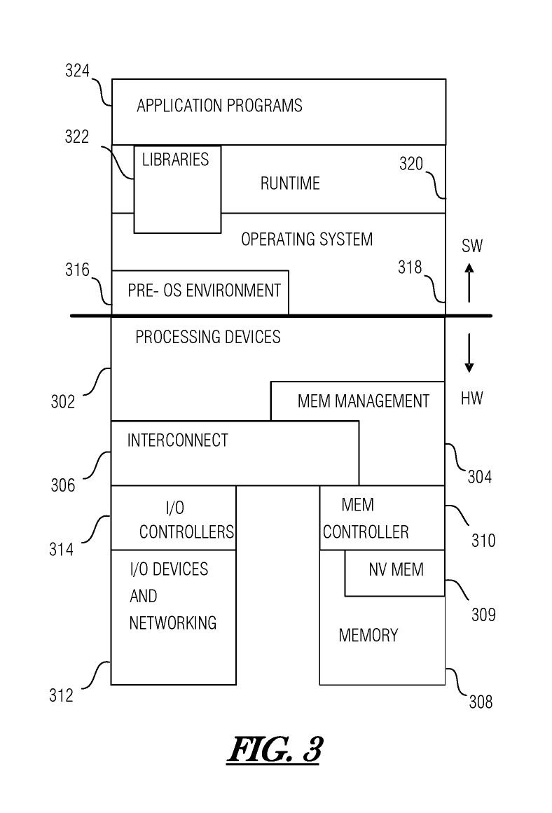

FIG. 3 is a diagram illustrating an exemplary hardware and software architecture of a computing platform on which various aspects of the embodiments may be realized. The computing platform may be transformed into a special-purpose machine by instructions that, when executed, cause the computing platform to carry out operations in accordance with one or more embodiments of the invention. In FIG. 3, various interfaces between hardware components and software components are shown. As indicated by HW, hardware components are represented below the divider line, whereas software components denoted by SW reside above the divider line. On the hardware side, processing devices 302 (which may include one or more microprocessors, digital signal processors, etc.), each having one or more processor cores, are interfaced with memory management device 304 and system interconnect 306. Memory management device 304 provides mappings between virtual memory used by processes being executed, and the physical memory. Memory management device 304 may be an integral part of a central processing unit which also includes the processing devices 302.

Interconnect 306 includes a backplane such as memory, data, and control lines, as well as the interface with input/output devices, e.g., PCI, USB, etc. Memory 308 (e.g., dynamic random access memory—DRAM) and non-volatile memory 309 such as flash memory (e.g., electrically-erasable read-only memory—EEPROM, NAND Flash, NOR Flash, etc.) are interfaced with memory management device 304 and interconnect 306 via memory controller 310. This architecture may support direct memory access (DMA) by peripherals in some embodiments. I/O devices, including video and audio adapters, non-volatile storage, external peripheral links such as USB, Bluetooth, etc., as well as network interface devices such as those communicating via Wi-Fi or LTE-family interfaces, are collectively represented as I/O devices and networking 312, which interface with interconnect 306 via corresponding I/O controllers 314.

On the software side, a pre-operating system (pre-OS) environment 316, which is executed at initial system start-up and is responsible for initiating the boot-up of the operating system. One traditional example of pre-OS environment 316 is a system basic input/output system (BIOS). In present-day systems, a unified extensible firmware interface (UEFI) is implemented. Pre-OS environment 316, described in greater detail below, is responsible for initiating the launching of the operating system, but also provides an execution environment for embedded applications according to certain aspects of the invention. Operating system (OS) 318 provides a kernel that controls the hardware devices, manages memory access for programs in memory, coordinates tasks and facilitates multi-tasking, organizes data to be stored, assigns memory space and other resources, loads program binary code into memory, initiates execution of the application program which then interacts with the user and with hardware devices, and detects and responds to various defined interrupts. Also, operating system 318 provides device drivers, and a variety of common services such as those that facilitate interfacing with peripherals and networking, that provide abstraction for application programs so that the applications do not need to be responsible for handling the details of such common operations. Operating system 318 additionally provides a graphical user interface (GUI) that facilitates interaction with the user via peripheral devices such as a monitor, keyboard, mouse, microphone, video camera, display, and the like.

Runtime system 320 implements portions of an execution model, including such operations as putting parameters onto the stack before a function call, the behavior of disk input/output (I/O), and parallel execution-related behaviors. Runtime system 320 may also perform support services such as type checking, debugging, or code generation and optimization.

Libraries 322 include collections of program functions that provide further abstraction for application programs. These include shared libraries, dynamic linked libraries (DLLs), for example. Libraries 322 may be integral to the operating system 318, runtime system 320, or may be added-on features, or even remotely-hosted. Libraries 322 define an application program interface (API) through which a variety of function calls may be made by application programs 324 to invoke the services provided by the operating system 318. Application programs 324 are those programs that perform useful tasks for users, beyond the tasks performed by lower-level system programs that coordinate the basis operability of the computing device itself.

Examples, as described herein, may include, or may operate on, logic or a number of circuits, components, modules, or engines, which for the sake of consistency are termed engines, although it will be understood that these terms may be used interchangeably. Engines are tangible entities capable of performing specified operations and may be configured or arranged in a certain manner. Engines may be realized as hardware circuitry, as well one or more processors programmed via software or firmware (which may be stored in a data storage device interfaced with the one or more processors), in order to carry out the operations described herein. In this type of configuration, an engine includes both, the software, and the hardware (e.g., circuitry) components. In an example, circuits may be arranged (e.g., internally or with respect to external entities such as other circuits) in a specified manner as an engine. In an example, the whole or part of one or more computer systems (e.g., a standalone, client or server computer system) or one or more hardware processors may be configured by firmware or software (e.g., instructions, an application portion, or an application) as an engine that operates to perform specified operations. In an example, the software may reside on a machine-readable medium. In an example, the software, when executed by the underlying hardware of the engine, causes the hardware to perform the specified operations. Accordingly, the term hardware engine is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. With reference to FIG. 3, for instance, an engine may include one, or any combination, of the blocks depicted, so long as at least one block from the HW side is included.

Considering examples in which engines are temporarily configured, each of the engines need not be instantiated at any one moment in time. For example, where the engines comprise a general-purpose hardware processor configured using software; the general-purpose hardware processor may be configured as respective different engines at different times. Software may accordingly configure a hardware processor, for example, to constitute a particular engine at one instance of time and to constitute a different engine at a different instance of time. In view of the above definition, engines are structural entities that have both, a physical structure, and an algorithmic structure. According to some embodiments, engines may constitute the structural means for performing certain algorithmic functions described herein.

A computing platform according to embodiments of the invention is a special-purpose machine that may be configured based on a general-purpose computing device, such as a personal computer (PC) having an architecture such as the one described in the example of FIG. 3. The computing platform may be one physical machine, or may be distributed among multiple physical machines, such as by role or function, or by process thread in the case of a cloud computing distributed model. In various embodiments, aspects of the embodiments may be configured to run in virtual machines that in turn are executed on one or more physical machines. It will be understood by persons of skill in the art that features of the invention may be realized by a variety of different suitable machine implementations.

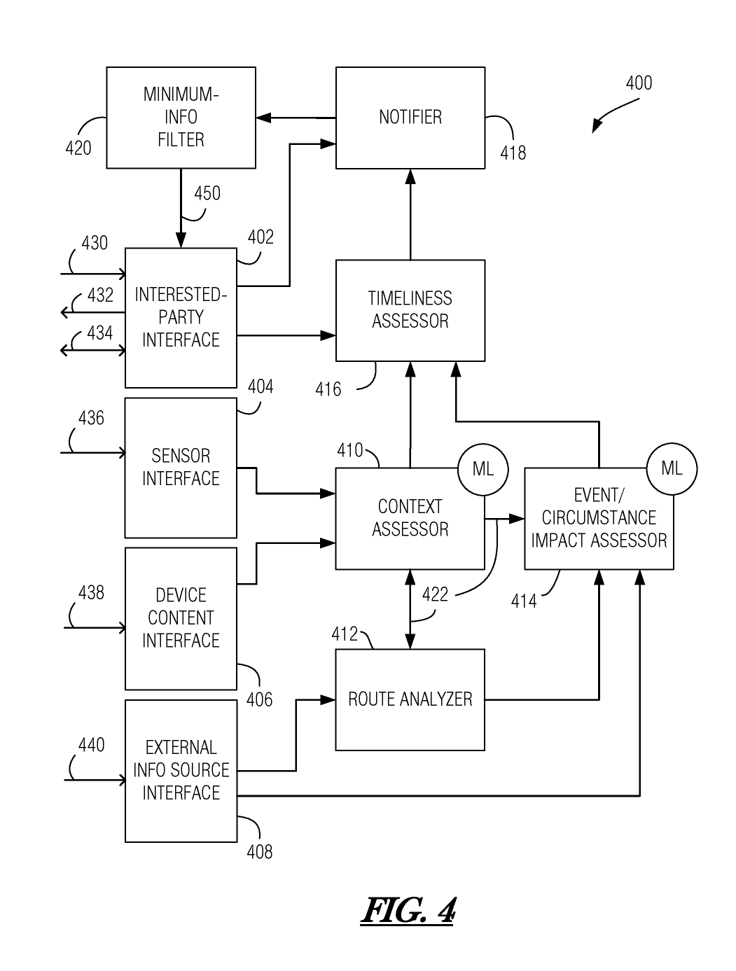

FIG. 4 is a system block diagram illustrating a location or movement-based alert system 400 according to an example embodiment. In various examples, system 400 includes engines, which may be implemented using the hardware, or the hardware controlled by software or firmware, of a computing device such as described above with reference to FIGS. 1-3. For instance, various engines (or the entirety) of system 400 may be implemented using one or more of SoCs 242-246, in combination with components 202-230 (FIG. 2).

At an overview level, system 400 obtains location information and, optionally, sensed input from its surrounding environment, such as sounds, images, and the like. In addition, certain usage and content information from the computing device may be collected and analyzed to assess the current context in which the device is operating, and from which the subject's movement, travel, or other activity may be inferred. The collected information is processed to determine whether the subject has an expected (e.g., planned or habitual) trip to a particular destination, and to assess the subject's travel-related activity in relation to the destination and expected arrival time. The subject's estimated time of arrival (ETA) may be computed, and re-computed in response to changes in circumstances such as traffic delays, or unexpected stops or route changes from the expected route. The system produces a notification for one or more interested parties, such as the entity with whom the subject is expected to meet at the destination. Notably, as described in greater detail below, the information contained in the notification is filtered to ensure that it omits personal or private information beyond a specified level of candor.

In an example embodiment, system 400 includes various communication interfaces 402-408. Interested-party interface 402 is constructed, programmed, or otherwise configured, to establish a trust relationship with an interested party that is interested in the subject's arrival at a destination. As discussed above, the interested party may be a mobile device belonging to a human user, or it may be an information system working on behalf of a business entity, for instance. The interested party in this context may have a specific level of trust with the subject of system 400, and different interested parties may have correspondingly different levels of trust represented in system 400. The trust relationship with the interested party may be set up with or without the direct involvement of the subject of system 400. For instance, an autonomous protocol may be carried out between system 400 and an interested party that may establish messaging formats, data-communication security such as cryptographic protections, etc.

As an illustrative example, an interested party may be a doctor's office appointment-scheduling system having an interest in knowing the subject's timeliness with respect to an upcoming appointment. An interested party may also be a spouse, child, parent, friend, co-worker, customer, autonomous vehicle or other automated system, or another third party with whom the subject may interact. Any of these entities may have a specific level of interest in the subject's travel to a destination, or other whereabouts. An interested third party may be initially established as such based on being present among the subject's contacts on system 400.

Various interaction protocols are contemplated with interested parties, and different individual interested parties may use a corresponding different protocol from others. For example, a doctor's office scheduling system may send one or more requests 430 to device 400 via interested-party interface 402 in the form of an email, SMS/MMS message, a representational state transfer (RESTful) interface message, a message sent via an application programming interface (API) or the like, requesting notification 432 regarding the subject's travel to the destination for an upcoming appointment. Request 430 may be implicit, such as having been set up at the time of the making of the appointment, in the form of an agreement from the subject to provide travel-to-destination notifications 450 via system 400. In the latter example, system 400 may provide the notifications 450 on a push basis in which notifications are provided by system 400 without external prompting.

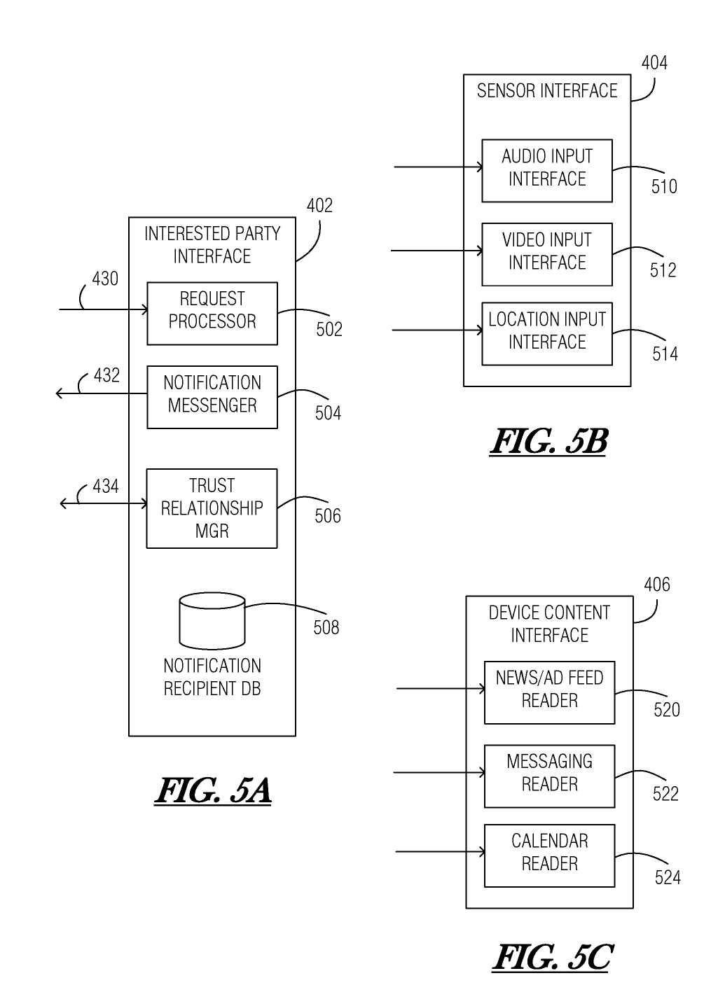

FIG. 5A illustrates an example of interested-party interface 402 according to an example. Request processor 502 is constructed, programmed, or otherwise configured, to receive requests 430 for notification from one or more interested parties, and to call on other engines of system 400 to carry out the operations leading to the generation of notification 432. In a related embodiment, request processor 502 produces a call for notification without there being an explicit request for each notification; rather, in this example, processor 502 calls for a notification to be issued in response to a prior notification configuration that defines conditions, the occurrence of which generates a call for notification for a given interested party.

Notification messenger 504 is constructed, programmed, or otherwise configured, to issue notifications 432 to interested party recipients according to an agreed-upon content, format, and mode of delivery. The notification may include an email, a SMS/MMS message, a hypertext transfer protocol (HTTP) message, a file transfer protocol (FTP) message, information exchange using a RESTful interface, a message sent via an application programming interface (API) or a message constructed and sent any suitable messaging format.

Trust relationship manager 506 is constructed, programmed, or otherwise configured, to execute a trust-relationship establishment protocol 434 with an interested party. In the trust-relationship establishment protocol, the interested party and trust relationship manager may exchange the interested party's preference for information to be included in notifications, and the limits on such information that the subject may have established for the device.

For example, in a doctor's office appointment scenario, the interested party's appointment scheduling system may indicate to trust relationship manager 506 that it wishes to be notified, by SMS, as to the subject's ETA, with the notification occurring at ½ hour prior to the scheduled appointment time, if the subject is not likely to arrive on time for the appointment. Trust relationship manager 506 may either accept the notification content, format, and mode of delivery requested by the appointment scheduling system, or it may offer a counter-proposal indicating a different content, format, or mode of delivery of notification. For instance, if the subject has preconfigured trust relationship manager 506 to withhold the ETA from interested parties falling outside a specified “inner circle” of more-highly-trusted parties, trust relationship manager 506 may offer a notification that includes a likelihood of timeliness (e.g., 70% likely to arrive on time) rather than the specific ETA. The interested party may accept or reject the counter-proposal. In the case of acceptance, the result would be a negotiated content, format, and mode of delivery of timeliness notification. In the case of non-acceptance, trust relationship manager 506 may seek approval from the subject via user interface to exceed the preconfigured default level of candor of notification. Advantageously, this example protocol enables automated establishment of a trust relationship with an interested party for which timeliness notifications are to be provided, with minimal subject involvement.

Notification recipient database 508 may contain agreed-upon content, format, and mode of delivery of notifications for a plurality of different interested parties, for example. Depending on the trust level specified for each of the interested parties, the degree of candor in the respective timeliness notifications may vary. For instance, a spouse may receive the most detailed notification content; whereas a child, friend, or coworker may receive less-detailed notification content. Each notification recipient may be associated with a recipient-specific notification format and mode of delivery to be used in executing the corresponding notification.

Referring again to FIG. 4, system 400 includes two types of input interfaces from which the current context may be determined by context assessor 410: sensor interface 404, and device content interface 406. Sensor interface 404 receives sensor input 436 from sensors present in, or accessible by, the system 400. Device content interface 406 reads informational content 438 stored on the subject's mobile device.

FIG. 5B illustrates sensor interface 404 in greater detail according to an example. Sensor interface 404 includes audio input interface 510, such as input from a microphone, for example. Also, sensor interface 404 includes video input interface 512 (e.g., accepting the output from a camera), and location input interface 514 (e.g., accepting the output from a GPS device or WiFi/LTE-based location service).

FIG. 5C illustrates device content interface 406 in greater detail according to an example. Device content interface 406 includes news or advertisement feed reader 520 configured to read content from various subscription services, messaging reader 522, which is configured to read content from incoming email, short messaging system or multimedia messaging system (SMS/MMS) messages, social media updates, and the like, and calendar reader 524 configured to read the content of the subject's calendar entries, contacts, travel itinerary, and other personal-relationship or subject-activity-informative data.

Returning to FIG. 4, external information source interface 408 is constructed, programmed, or otherwise configured, to query, receive push notifications, or otherwise access third-party-originated information 440. Examples of third-party-originated information 440 include real-time traffic, weather, road closures, accidents, construction projects, and the like. Third-party-originated information may also include a database, such as a business-listing directory, which may be queried by external information source interface 408.

Context assessor 410 is constructed, programmed, or otherwise configured, to interpret sensor input 436 and informational content 438, and based thereupon, to assess the present context in which the computing device is being used. The indicator ML represents a machine-learning component being incorporated as part of context assessor 410. The present context may represent computed deductions or inferences regarding the current activity or environment of the subject.

For example, the present context may indicate whether the subject is in transit, the mode of transportation (e.g., aircraft, auto, motorcycle, bicycle, bus, train, on foot, etc.), whether the subject has stopped during travel, whether the subject has engaged in a new activity, etc. These types of activities may be determined from the sensor input. For instance, the speed or patterns of travel may distinguish the mode of transportation between on-foot, bicycle, and motorized modes. Other sensed indicia, such as sound, video images, accelerometer data, or the like, may further distinguish auto vs. motorcycle, vs. bus, vs. rail transportation modes.

Informational content 438 may also be analyzed to determine context. For instance, a scheduled appointment or meeting indicating destination location, or a contact with whom the appointment or meeting is to take place, is indicative of the subject's likelihood to travel towards the place of appointment/meeting in advance of the appointment time.

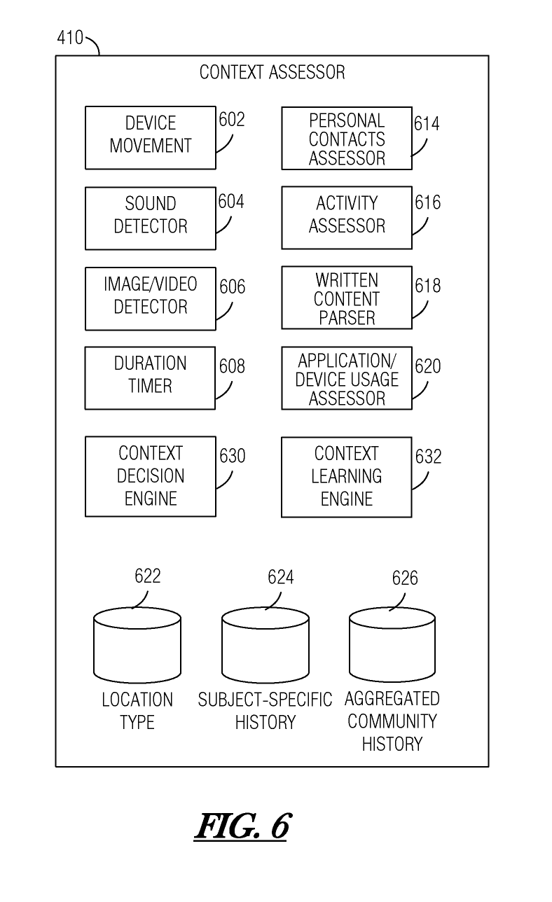

FIG. 6 is a block diagram illustrating various components of context assessor 410 according to an example embodiment. These components may each use one, or a combination, of inputs to make various deductions or inferences regarding the present context.

As depicted, context assessor 410 includes device movement tracker 602, which gathers location and motion information to determine direction and speed of travel at given time samples. Context assessor 410 includes sound detector 604 that is configured to recognize and distinguish between various sounds, such as human speech, chimes, sirens, alarms, machinery, and the like. Image/video detector 606 is configured to analyze captured photo or motion video clips to assist in the determination of the subject's surroundings (e.g., outdoors, in street, in vehicle, indoors, in a crowd, etc.). Duration timer 608 is configured to assess how long the subject has been engaged in an assessed or suspected activity or at a certain location.

Personal contacts assessor 614 is configured to draw connections between individuals named in incoming messaging or calendar entries, and the subject's contact database, social media, or other information source, to assess the nature and extent of the personal relationships of those individuals and the subject of the computing device. This information may be relevant to prioritizing the monitoring of certain types of monitored events. This information may also be relevant to assessing whether the subject intends to proceed to a destination. In an example scenario, personal contacts assessor 614 may read and interpret a SMS message from the subject's spouse as indicating that the spouse intends to proceed to a destination in lieu of the subject. As a related embodiment, in the present example, system 400 may generate a notification to the spouse confirming the subject's intention to forgo travel to the destination, and prompt the subject if he or she wishes to send it.

Activity assessor 616 is configured to deduce or infer the subject's current activity, such as travel, work, commuting, leisure, sport/exercise, gaming, sleep, attendance at certain venues, such as restaurants, theaters, stores, stadiums, etc. Written content parser 618 is configured to extract certain keywords or main ideas from monitored communications. Application/device usage assessor 620 is configured to monitor the nature of the subject's current work on, or interaction with, the computing device, such as listening to music, use of virtual- or augmented-reality system, watching video content, gaming, use of headphones, speaking via telephone or video conferencing system, etc.

Context assessor 410 may also include various databases, such as location type database 622, which maintains a knowledge base of types of businesses or points of interest, at their corresponding locations. Information on location type may be obtained via external information source interface 408, such as a query of a directory service, for example.

Subject-specific history database 624 may maintain a log of the subject's routes, stops, activities, and durations thereof. This information may be used to learn and predict the subject's behavior and preferences. For instance, the subject may have a general preference for minimizing the time spent at gas stations; the subject may generally pay at the pump and avoid entering the retail store. A different subject, may generally prefer to enter the shop to purchase various items, which would tend to increase the average time spent at gas stations.

Aggregated community history 626 is a periodically-updated database of general trends among multiple different subjects with respect to activities, durations, etc. This type of information may be anonymously collected and aggregated from subjects who elect to participate in a community-sharing service. The aggregated community history information may be used to more accurately predict the impact of an activity that a subject appears to be undertaking when there is little or no subject-specific history for that subject. For example, if the subject is assessed to have stopped at a certain store for the first time, the projected duration of the visit may be estimated based on how long other visitors have tended to visit that store.

Context decision engine 630 is constructed, programmed, or otherwise configured, to perform the context assessment based on the output of all of the above-described engines. Context-decision engine 630 may be a rules-based decision system, or it may have any other suitable architecture, such as a clustering engine, an anomaly-detection engine, a reinforcement learning engine, an artificial neural network engine, a classification engine, or the like. Context decision engine 630 may work closely in conjunction with context learning engine 632, which may perform training and reinforcement operations to improve the accuracy of the context decision engine 630 over time.

Returning again to FIG. 4, individually, or in various combinations, the components of context assessor 410 produce context indicia 422. In various embodiments, context indicia 422 includes event descriptors extracted from received information as part of the context analysis, as well as computing device operational state, location, movement, assessed subject activity, expected future subject activity (e.g., based on scheduled appointments) and other current context information.

Route analyzer 412 is constructed, programmed, or otherwise configured, to determine the route being taken by the subject when the subject is believed to be in transit to a destination. As an example, route analyzer 412 may assess context indicia 422 to determine whether the subject is traveling to a destination, and what locations along the logged travel path were passed by the subject. Route analyzer 412 may also obtain relevant information from external sources, such as traffic/incident reports, weather reports, and the like, to assess the subject's transit time based on the context indicia 422, and on the totality of monitored circumstances.

Event/circumstance impact assessor 414 is constructed, programmed, or otherwise configured, to detect changes over time in context indicia 422 and the output of route analyzer 412, as well as information from external sources, as gathered by external information source interface 408, and to assess the impact of these changes on the ETA determination. For example, a deviation from the subject's predicted route (e.g., a stop at a certain location) is likely to add time to the subject's travel duration. Event/circumstance impact assessor 414 works to quantify that impact based on historical data and various other decision or assessment criteria. The architecture of event/circumstance impact assessor 414 may include a rules-based decision system, or it may have any other suitable architecture, such as a clustering engine, an anomaly-detection engine, a reinforcement learning engine, an artificial neural network engine, a classification engine, or the like.

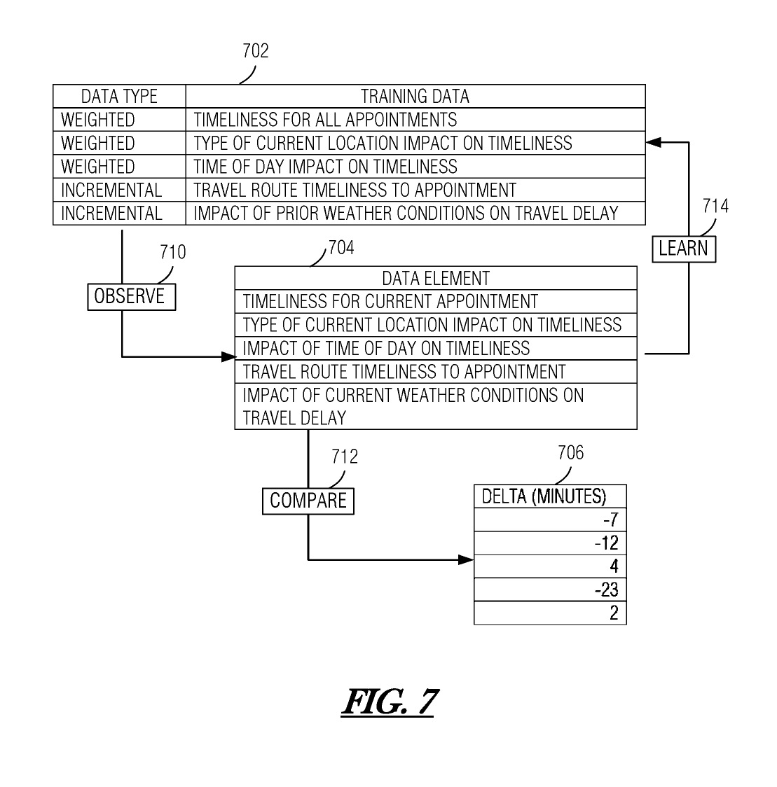

In a related embodiment, as depicted, event/circumstance impact assessor 414 may include a machine-learning component ML that is configured to refine the impact assessments over time to improve their accuracy. The machine-learning architecture may take any suitable form to work with any of the decision system architectures mentioned above. FIG. 7 is a diagram illustrating an example machine-learning-based implementation of event/circumstance impact assessor 414 according to an illustrative embodiment. This approach uses a set of training data 702 based on historical information such as the subject's general timeliness for appointments, the impact of a stop at the current location on timeliness, the impact of the time of day on timeliness, the timeliness of the current traffic route to the destination, the impact of weather on traffic delays along the current route. Each historical information item may have a weighted or incremental data type assigned, as shown. The actual timeliness impacts are measured and stored as data elements 704 with measured values 706 in terms of deltas from the initially-predicted timeliness. These are observed at 710 and compared against the historical values in training data 702 at 712. At 714 the training data 702 may be updated to reflect the actual measured values of the corresponding parameters. In some embodiments, more recent observations are given relatively greater weight in the learning operation 712 compared with older observations as the training data 702 is updated.

Returning to FIG. 4, timeliness assessor 416 is constructed, programmed, or otherwise configured, to compute the ETA based on the current context and any updates based on events or changes in circumstances, and to compare the ETA determination based on the output of route analyzer 412, event/circumstance impact determined by 414, and context indicia 422, against the scheduled time of the appointment or meeting at the destination, as obtained via interested-party interface 402 or from the subject's calendar, for example, to determine the actual timeliness of the subject's projected arrival at the destination. The timeliness determination may be represented as an ETA delta, or it may be represented stochastically, such as in terms of likelihood of timeliness, or in terms of computed ETA with assessed margin of error, for example.

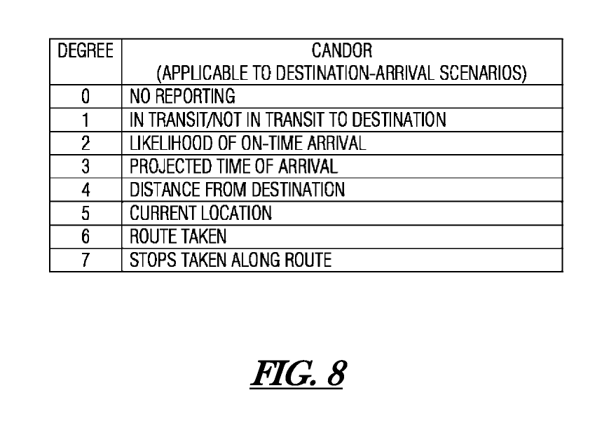

Notifier 418 is constructed, programmed, or otherwise configured, to generate notification content for one or more interested parties, in response to corresponding calls for notification. As discussed above, different degrees of candor may be present in the notifications, depending on the established trust level of the interested party that is to receive notification. FIG. 8 is a table listing an example set of levels of candor for notifications relating to destination-arrival scenarios consistent with the operational examples heretofore described. Eight levels of candor are present in this example for illustrative purposes, though it will be understood that a variety of other types of content, candor, and granularity of incremental candor may be applied in various other embodiments.

As depicted in FIG. 8, degrees 0-7 progressively offer more detailed reporting information. Degree 0 corresponds to no reporting. This option may be set for interested parties with whom the subject does not wish to correspond, for example. Degree 1 represents a simple binary indicator of whether the subject is, or is not, in transit to the destination. This degree of candor provides some useful information to the recipient about the subject's intention to arrive, but it provides no information regarding timing or timeliness of the arrival. Degree 2 represents a stochastic indication of on-time arrival, such as “70% likely to arrive at scheduled time.” This degree of candor withholds the projected arrival time from the notification recipient. Degree 3 shares the ETA with the notification recipient, but withholds distance or location information of the subject. Degree 4 shares the distance from the destination with the recipient, but withholds the subject's location. Degree 5 provides the subject's current location, but withholds route information that may indicate past and future locations of the subject as the subject traverses the expected route. Degree 6 includes the route information with the notification recipient, but excludes any details about the subject's stops along the route taken. Degree 7 includes the stops in addition to the route information.

In a related embodiment, each progressive degree of candor includes information corresponding to the lower degrees. In another embodiment, certain information of lower degrees of candor may be excluded. For example, degree 4 (distance from destination) may exclude an indication of whether the subject still intends to proceed to the destination (degree 1), and it may likewise exclude degrees 2 and 3 corresponding to the timeliness and ETA.

In another related embodiment, a default degree of candor may be specified based on subject preferences. Thus, in the absence of a specifically increased or decreased degree of candor for a particular interested party, as may be specified by the subject, a level of detail not exceeding the configured default degree of candor may be set for notification generation.

In another embodiment, notifier 418 may be configured to apply different degrees of candor depending on the situational circumstances calling for notification. By way of example, the subject's transit to a doctor's appointment may call for a lower degree of candor (e.g., level 1 or 2), than the case where the subject may be subject to a health emergency and needs medical assistance. In this example, although the subject's doctor may not be called to respond to the scene of the emergency, they may eventually attend to the subject, and having more information about the context surrounding the accident may be beneficial for developing a treatment plan for the subject. Therefore, in response to an emergency situation that calls for notification of an interested party, a higher degree of candor (e.g., level 6 or 7) may be permitted as part of the notification.

Turning back to FIG. 4, in a related embodiment, minimum-information filter 420 is constructed, programmed, or otherwise configured, to independently review and filter the information content of notifications before they are sent by system 400. Minimum-information filter 420 produces minimally-informative notification 450 to be sent as notification 432.

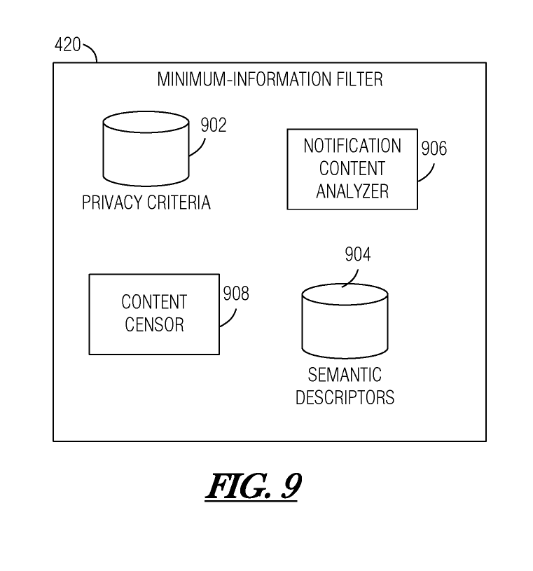

FIG. 9 is a diagram illustrating minimum-information filter 420 in greater detail according to an example embodiment. As depicted, minimum-information filter 420 includes privacy criteria 902. Privacy criteria 902 may be represented as a candor limit, for example. For instance, criteria 902 may define a degree of candor, such as from among degrees 0-7 shown in FIG. 8, beyond which divulging of detail is prohibited. Criteria 902 may be associated with semantic descriptors 904 corresponding with different degrees of candor. Notification content analyzer 906 is constructed, programmed, or otherwise configured, to apply the privacy criteria, along with corresponding semantic descriptors 904, to the textual substance of the notification generated by notifier 418 to determine whether the substance of the notification exceeds the permitted privacy criteria 902.

In a related embodiment, privacy criteria 902 is destination-specific. For example, the subject may specify that all notifications corresponding to a first destination location (e.g., place of business) are to be at or below candor level 2. Similarly, for a second destination (e.g., home), the candor-level limit may be 5, or example.

In another related embodiment, privacy criteria 902 may simply be recipient-specific, with a default setting for all recipients for whom no specific limit is established.

In another related embodiment, a set of situational exceptions are preconfigured in privacy criteria 902 to accommodate emergencies or other defined contextual situations where variations in the candor-level limit may be justified.

In one type of embodiment, the architecture of system 400 may provide for the installation of interested-party-supplied interface component 402 and notifier component 418. This arrangement may provide added convenience for both, the subject, and the interested party, in the setup and use of system 400. According to this embodiment, multiple interested-party interfaces 402 and multiple notifiers 418 may be supported. In such cases, minimum-information filter 420 may play a particularly important role, as its operation supersedes that of notifier 418.

Content censor 908 is constructed, programmed, or otherwise configured, to either permit the notification as generated (provided that it meets privacy criteria 902 as per notification content analyzer 906) or to parse, and remove information that exceeds the permitted level of candor. For instance, a notification consistent with candor level 3 (FIG. 8) that states “In transit. Projected time of arrival: 13:20” may be censored as follows: “In transit.” or “In transit. Projected time of arrival: later than appointment time.”

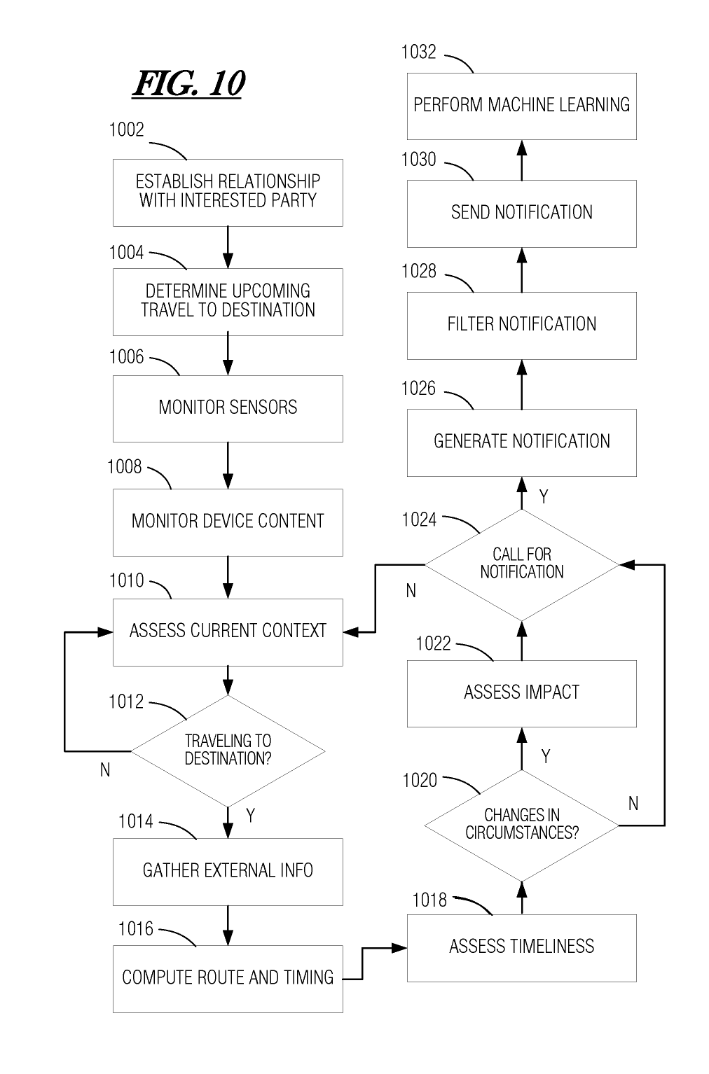

FIG. 10 is a flow diagram illustrating an example of the operation of system 400 according to various embodiments. It is important to note that the example process represents richly-featured embodiments that may be realized as described; in addition, portions of the process may be implemented while others are excluded in various embodiments. The following Additional Notes and Examples section details various combinations, without limitation, that are contemplated. It should also be noted that in various embodiments, certain process operations may be performed in a different ordering than depicted, provided that the logical flow and integrity of the process is not disrupted in sub stance.

At 1002, interested-party interface 402 establishes a trust relationship with an interested party. Notification content, format, and mode of delivery may be negotiated. In a related embodiment, interested-party interface is provided as a component to system 400 by the interested party and these parameters are preset. At 1004, upcoming travel to a destination is determined. This may be accomplished by messaging with the interested party via interested-party interface 402, or by review of the subject's calendar.

At 1006, sensor interface 404 monitors sensors of the device, particularly the location sensing arrangement(s). Additional sensors may also be monitored to collect data from which context may be more accurately determined. At 1008, device content is monitored via device content interface 406. At 1010, context assessor 410 analyzes the sensor information and device content information to determine a current context. At 1012, context assessor 410 determines, from the current context, whether the subject is traveling to the destination. If no underway travel has been detected, current context assessment continues. Otherwise, in response to detected travel to the destination, external information source interface 1014 gathers externally-supplied information, such as traffic, weather, directory information, etc.

At 1016 route analyzer 1016 determines, predictively, the route that the subject is likely to follow. and, based thereupon, generates an initial timing estimate. At 1018, timeliness assessor 416 determines an ETA based on the route information and on the present context. At 1020, context assessor 410 determines whether any changes in subject behavior, or outside circumstances, have occurred. In the affirmative case, at 1022, event/circumstance impact assessor 414 determines whether, and to what extent, the ETA is impacted, and adjustment to the ETA is made accordingly.

At 1024, based on notification criteria negotiated by interested-party interface 402, notifier 418 determines whether the criteria calling for notification is met. The criteria may be passage of a time interval, or it may be based on a change in circumstances that affects the ETA by at least some specified threshold amount. In the affirmative case, at 1026, notifier 418 generates a notification containing content and format according to the negotiated parameters. At 1028 minimum-information filter 420 analyzes the content of the notification, and either permits, or censors, the notification based on the privacy criteria 902. At 1030, interested-party interface 402 sends the notification.

At 1032, context assessor 410 and event/circumstance impact assessor 414 perform machine-learning operations according to their respective machine-learning schemes or architectures.

### ADDITIONAL NOTES & EXAMPLES

Example 1 is a system for reporting activity of a subject, the system comprising: a mobile computing platform, including processor circuitry data storage circuitry, and communications circuitry, the data storage circuitry containing instructions that, when executed, cause the mobile computing platform to implement: an interested-party interface to communicate with an entity that is interested in arrival at a destination by the subject; a context assessor to generate context indicia relating to usage of the mobile computing platform based on sensor data and content data of the mobile computing platform, the usage of the mobile computing platform including travel to the destination; a timeliness assessor to determine an estimated time of arrival (ETA) of the subject at the destination based on the context indicia; a change impact assessor to determine an impact of any changes in the context indicia on the ETA, wherein the ETA is to be updated based on the impact; a notifier to generate timeliness notification content to be included in a notification to the entity, wherein the timeliness notification content is generated based on a predefined degree of candor from among multiple degrees of candor regarding the timeliness of the ETA; and a privacy filter to apply privacy criteria that defines a content limit to the timeliness notification, wherein any content of the timeliness notification that exceeds the content limit is removed to produce a minimally-informative notification to be communicated to the entity via the interested-party interface.

In Example 2, the subject matter of Example 1 optionally includes wherein the interested-party interface is to automatically negotiate the degree of candor regarding the timeliness of the ETA to be provided in the timeliness notification, with the entity.

In Example 3, the subject matter of any one or more of Examples 1-2 optionally include wherein the notifier is a component installed in the system, the component having been provided by the entity.

In Example 4, the subject matter of any one or more of Examples 1-3 optionally include wherein the context assessor includes a machine-learning engine that performs reinforcement-learning operations to improve accuracy of the context assessor over time.

In Example 5, the subject matter of any one or more of Examples 1-4 optionally include wherein the change impact assessor includes a machine-learning engine that performs reinforcement-learning operations to improve accuracy of the change impact assessor over time.

In Example 6, the subject matter of any one or more of Examples 1-5 optionally include wherein the predefined degree of candor includes an indicator regarding timeliness of the subject relative to a scheduled time of arrival, but excludes current ETA information.

In Example 7, the subject matter of any one or more of Examples 1-6 optionally include wherein the predefined degree of candor includes an indicator regarding timeliness of the subject relative to a scheduled time of arrival, but excludes current location information.

In Example 8, the subject matter of any one or more of Examples 1-7 optionally include wherein the predefined degree of candor includes a stochastic indicator regarding timeliness of the subject relative to a scheduled time of arrival.

In Example 9, the subject matter of any one or more of Examples 1-8 optionally include wherein the privacy filter includes a semantic analyzer to assess textual substance of the notification generated by the notifier.

In Example 10, the subject matter of any one or more of Examples 1-9 optionally include wherein the privacy filter includes a notification content analyzer that assesses whether any of the content of the notification exceeds the predefined degree of candor regarding the timeliness of the ETA, and a content censor to remove any of the content exceeding the predefined degree of candor.

In Example 11, the subject matter of any one or more of Examples 1-10 optionally include wherein the privacy filter includes a situational exception to the privacy criteria that permits content beyond the content limit to be included in the notification in response to context indicia that indicate an emergency situation.

In Example 12, the subject matter of any one or more of Examples 1-11 optionally include wherein the interested-party interface is to communicate with a plurality of distinct entities, and wherein the privacy criteria applied by the privacy filter is entity-specific such that different criteria corresponds to different individual entities.

In Example 13, the subject matter of any one or more of Examples 1-12 optionally include wherein the notifier is to generate a plurality of distinct notification types corresponding to different destinations, and wherein the privacy criteria applied by the privacy filter is notification-type-specific such that different criteria corresponds to different destinations.

In Example 14, the subject matter of any one or more of Examples 1-13 optionally include wherein the context assessor is to maintain a history log of location-specific stops by the subject and associated durations for those stops, and wherein the change impact assessor is to take into account the associated duration for a location at which the subject stops during the travel to the destination in its determination of the impact of any changes in the context indicia on the ETA.

In Example 15, the subject matter of any one or more of Examples 1-14 optionally include wherein the system is incorporated as part of an autonomous vehicle.

In Example 16, the subject matter of any one or more of Examples 1-15 optionally include wherein the system is incorporated as part of a hand-portable mobile computing device that includes a human-interface device.

In Example 17, the subject matter of any one or more of Examples 1-16 optionally include wherein the sensor data and the content data are generated locally on the mobile computing platform.

Example 18 is a machine-implemented method for reporting activity of a subject, the method being executed autonomously by a computing device, and comprising: generating context indicia relating to usage of the device based on sensor data and content data of the device, the usage of the device including travel to the destination; determining an estimated time of arrival (ETA) of the subject at the destination based on the context indicia; determining an impact of any changes in the context indicia on the ETA, wherein the ETA is to be updated based on the impact; generating timeliness notification content to be included in a notification to an entity that is interested in arrival at a destination by the subject, wherein the timeliness notification content is generated based on a predefined degree of candor from among multiple degrees of candor regarding the timeliness of the ETA; and applying privacy criteria that defines a content limit to the timeliness notification, wherein any content of the timeliness notification that exceeds the content limit is removed to produce a minimally-informative notification to be communicated to the entity.

In Example 19, the subject matter of Example 18 optionally includes automatically negotiating the degree of candor regarding the timeliness of the ETA to be provided in the timeliness notification, with the entity.

In Example 20, the subject matter of any one or more of Examples 18-19 optionally include performing reinforcement-learning operations to improve accuracy of the context assessment over time.

In Example 21, the subject matter of any one or more of Examples 18-20 optionally include performing reinforcement-learning operations to improve accuracy of the change impact assessment over time.

In Example 22, the subject matter of any one or more of Examples 18-21 optionally include wherein the predefined degree of candor includes an indicator regarding timeliness of the subject relative to a scheduled time of arrival, but excludes current ETA information.

In Example 23, the subject matter of any one or more of Examples 18-22 optionally include wherein the predefined degree of candor includes an indicator regarding timeliness of the subject relative to a scheduled time of arrival, but excludes current location information.

In Example 24, the subject matter of any one or more of Examples 18-23 optionally include wherein the predefined degree of candor includes a stochastic indicator regarding timeliness of the subject relative to a scheduled time of arrival.

In Example 25, the subject matter of any one or more of Examples 18-24 optionally include wherein the privacy criteria are based on semantic analysis of textual substance of the notification.

In Example 26, the subject matter of any one or more of Examples 18-25 optionally include wherein the privacy criteria define criteria for assessing whether any of the content of the notification exceeds the predefined degree of candor regarding the timeliness of the ETA; and wherein the method further comprises removing any of the content exceeding the predefined degree of candor.

In Example 27, the subject matter of any one or more of Examples 18-26 optionally include wherein the privacy criteria include a situational exception to the privacy criteria that permits content beyond the content limit to be included in the notification in response to context indicia that indicate an emergency situation.

In Example 28, the subject matter of any one or more of Examples 18-27 optionally include generating a plurality of distinct notification types corresponding to different individual entities interested in the arrival of the subject at the destination, wherein the privacy criteria are entity-specific such that different criteria are applicable to different ones of the individual entities.

In Example 29, the subject matter of any one or more of Examples 18-28 optionally include generating a plurality of distinct notification types corresponding to different destinations, and wherein the privacy criteria is notification-type-specific such that different criteria correspond to different destinations.

In Example 30, the subject matter of any one or more of Examples 18-29 optionally include maintaining a history log of location-specific stops by the subject and associated durations for those stops, and the determining of the impact of any changes in the context indicia on the ETA includes taking into account the associated duration for a location at which the subject stops during the travel to the destination.

In Example 31, the subject matter of any one or more of Examples 18-30 optionally include wherein the method is executed by the computing device as part of operating an autonomous vehicle.

In Example 32, the subject matter of any one or more of Examples 18-31 optionally include wherein the method is executed by the computing device as part of operating a hand-portable mobile computing device that includes a human-interface device.

In Example 33, the subject matter of any one or more of Examples 18-32 optionally include wherein the sensor data and the content data are generated locally on the computing device.

Example 34 is a system for reporting activity of a subject, the system comprising means for carrying out the method according to any one of Examples 18-33.

Example 35 is at least one machine-readable medium comprising instructions that, when executed by a computing device, cause the computing device to carry out the method according to any one of Examples 18-33.

Example 36 is at least one machine-readable medium containing instructions that, when executed on a computing device, cause the computing device to: generate context indicia relating to usage of the device based on sensor data and content data of the device, the usage of the device including travel to the destination by a subject; determine an estimated time of arrival (ETA) of the subject at the destination based on the context indicia; determine an impact of any changes in the context indicia on the ETA, wherein the ETA is to be updated based on the impact; generate timeliness notification content to be included in a notification to an entity that is interested in arrival at a destination by the subject, wherein the timeliness notification content is generated based on a predefined degree of candor from among multiple degrees of candor regarding the timeliness of the ETA; and apply privacy criteria that defines a content limit to the timeliness notification, wherein any content of the timeliness notification that exceeds the content limit is removed to produce a minimally-informative notification to be communicated to the entity.

In Example 37, the subject matter of Example 36 optionally includes instructions that, when executed, cause the computing device to automatically negotiate the degree of candor regarding the timeliness of the ETA to be provided in the timeliness notification with the entity.

In Example 38, the subject matter of any one or more of Examples 36-37 optionally include instructions that, when executed, cause the computing device to perform reinforcement-learning operations to improve accuracy of the context assessment over time.

In Example 39, the subject matter of any one or more of Examples 36-38 optionally include instructions that, when executed, cause the computing device to perform reinforcement-learning operations to improve accuracy of the change impact assessment over time.

In Example 40, the subject matter of any one or more of Examples 36-39 optionally include wherein the predefined degree of candor includes an indicator regarding timeliness of the subject relative to a scheduled time of arrival, but excludes current ETA information.

In Example 41, the subject matter of any one or more of Examples 36-40 optionally include wherein the predefined degree of candor includes an indicator regarding timeliness of the subject relative to a scheduled time of arrival, but excludes current location information.

In Example 42, the subject matter of any one or more of Examples 36-41 optionally include wherein the predefined degree of candor includes a stochastic indicator regarding timeliness of the subject relative to a scheduled time of arrival.

In Example 43, the subject matter of any one or more of Examples 36-42 optionally include wherein the privacy criteria are based on semantic analysis of textual substance of the notification.

In Example 44, the subject matter of any one or more of Examples 36-43 optionally include wherein the privacy criteria define criteria for assessing whether any of the content of the notification exceeds the predefined degree of candor regarding the timeliness of the ETA; and wherein the at least one machine-readable medium further comprises instructions that, when executed, cause the computing device to remove any of the content exceeding the predefined degree of candor.

In Example 45, the subject matter of any one or more of Examples 36-44 optionally include wherein the privacy criteria include a situational exception to the privacy criteria that permits content beyond the content limit to be included in the notification in response to context indicia that indicate an emergency situation.

In Example 46, the subject matter of any one or more of Examples 36-45 optionally include instructions that, when executed, cause the computing device to generate a plurality of distinct notification types corresponding to different individual entities interested in the arrival of the subject at the destination, wherein the privacy criteria are entity-specific such that different criteria are applicable to different ones of the individual entities.

In Example 47, the subject matter of any one or more of Examples 36-46 optionally include instructions that, when executed, cause the computing device to generate a plurality of distinct notification types corresponding to different destinations, and wherein the privacy criteria is notification-type-specific such that different criteria correspond to different destinations.

In Example 48, the subject matter of any one or more of Examples 36-47 optionally include instructions that, when executed, cause the computing device to maintain a history log of location-specific stops by the subject and associated durations for those stops, and wherein the impact of any changes in the context indicia on the ETA is based on the associated duration for a location at which the subject stops during the travel to the destination.

In Example 49, the subject matter of any one or more of Examples 36-48 optionally include instructions that, when executed, cause the computing device to locally generate the sensor data and the content data on the computing device.

Example 50 is a system for reporting activity of a subject, the system comprising: means for generating context indicia relating to usage of the device based on sensor data and content data of the device, the usage of the device including travel to the destination; means for determining an estimated time of arrival (ETA) of the subject at the destination based on the context indicia; means for determining an impact of any changes in the context indicia on the ETA, wherein the ETA is to be updated based on the impact; means for generating timeliness notification content to be included in a notification to an entity that is interested in arrival at a destination by the subject, wherein the timeliness notification content is generated based on a predefined degree of candor from among multiple degrees of candor regarding the timeliness of the ETA; and means for applying privacy criteria that defines a content limit to the timeliness notification, wherein any content of the timeliness notification that exceeds the content limit is removed to produce a minimally-informative notification to be communicated to the entity.

In Example 51, the subject matter of Example 50 optionally includes means for negotiating the degree of candor regarding the timeliness of the ETA to be provided in the timeliness notification, with the entity.

In Example 52, the subject matter of any one or more of Examples 50-51 optionally include means for performing reinforcement-learning operations to improve accuracy of the context assessment over time.

In Example 53, the subject matter of any one or more of Examples 50-52 optionally include means for performing reinforcement-learning operations to improve accuracy of the change impact assessment over time.

In Example 54, the subject matter of any one or more of Examples 50-53 optionally include wherein the predefined degree of candor includes an indicator regarding timeliness of the subject relative to a scheduled time of arrival, but excludes current ETA information.

In Example 55, the subject matter of any one or more of Examples 50-54 optionally include wherein the predefined degree of candor includes an indicator regarding timeliness of the subject relative to a scheduled time of arrival, but excludes current location information.

In Example 56, the subject matter of any one or more of Examples 50-55 optionally include wherein the predefined degree of candor includes a stochastic indicator regarding timeliness of the subject relative to a scheduled time of arrival.

In Example 57, the subject matter of any one or more of Examples 50-56 optionally include wherein the privacy criteria are based on semantic analysis of textual substance of the notification.

In Example 58, the subject matter of any one or more of Examples 50-57 optionally include wherein the privacy criteria define criteria for assessing whether any of the content of the notification exceeds the predefined degree of candor regarding the timeliness of the ETA; and wherein the system further comprises means for removing any of the content exceeding the predefined degree of candor.

In Example 59, the subject matter of any one or more of Examples 50-58 optionally include wherein the privacy criteria include a situational exception to the privacy criteria that permits content beyond the content limit to be included in the notification in response to context indicia that indicate an emergency situation.

In Example 60, the subject matter of any one or more of Examples 50-59 optionally include means for generating a plurality of distinct notification types corresponding to different individual entities interested in the arrival of the subject at the destination, wherein the privacy criteria are entity-specific such that different criteria are applicable to different ones of the individual entities.

In Example 61, the subject matter of any one or more of Examples 50-60 optionally include means for generating a plurality of distinct notification types corresponding to different destinations, and wherein the privacy criteria is notification-type-specific such that different criteria correspond to different destinations.

In Example 62, the subject matter of any one or more of Examples 50-61 optionally include means for maintaining a history log of location-specific stops by the subject and associated durations for those stops; and wherein the means for determining of the impact of any changes in the context indicia on the ETA include means for taking into account the associated duration for a location at which the subject stops during the travel to the destination.

In Example 63, the subject matter of any one or more of Examples 50-62 optionally include wherein the system is part of an autonomous vehicle.

In Example 64, the subject matter of any one or more of Examples 50-63 optionally include wherein the system is part of a hand-portable mobile computing device that includes a human-interface device.

In Example 65, the subject matter of any one or more of Examples 50-64 optionally include wherein the sensor data and the content data are generated locally on the computing device.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A system for reporting activity of a subject, the system comprising:
a mobile computing platform, including processor circuitry data storage circuitry, and communications circuitry, the data storage circuitry containing instructions that, when executed, cause the mobile computing platform to implement:
an interested-party interface to communicate with an entity that is interested in arrival at a destination by the subject;
a context assessor to generate context indicia relating to usage of the mobile computing platform based on sensor data and content data of the mobile computing platform, the usage of the mobile computing platform including travel to the destination;
a timeliness assessor to determine an estimated time of arrival (ETA) of the subject at the destination based on the context indicia;
a change impact assessor to determine an impact of any changes in the context indicia on the ETA, wherein the ETA is to be updated based on the impact;
a notifier to generate timeliness notification content to be included in a notification to the entity, wherein the timeliness notification content is generated based on a predefined degree of candor from among multiple degrees of candor regarding the timeliness of the ETA; and
a privacy filter to apply privacy criteria that defines a content limit to the timeliness notification, wherein any content of the timeliness notification that exceeds the content limit is removed to produce a minimally-informative notification to be communicated to the entity via the interested-party interface.

2. The system of claim 1, wherein the interested-party interface is to automatically negotiate the degree of candor regarding the timeliness of the ETA to be provided in the timeliness notification, with the entity.

3. The system of claim 1, wherein the notifier is a component installed in the system, the component having been provided by the entity.

4. The system of claim 1, wherein the context assessor includes a machine-learning engine that performs reinforcement-learning operations to improve accuracy of the context assessor over time.

5. The system of claim 1, wherein the change impact assessor includes a machine-learning engine that performs reinforcement-learning operations to improve accuracy of the change impact assessor over time.

6. The system of claim 1, wherein the privacy filter includes a semantic analyzer to assess textual substance of the notification generated by the notifier.

7. The system of claim 1, wherein the privacy filter includes a notification content analyzer that assesses whether any of the content of the notification exceeds the predefined degree of candor regarding the timeliness of the ETA, and a content censor to remove any of the content exceeding the predefined degree of candor.

8. The system of claim 1, wherein the privacy filter includes a situational exception to the privacy criteria that permits content beyond the content limit to be included in the notification in response to context indicia that indicate an emergency situation.

9. The system of claim 1, wherein the interested-party interface is to communicate with a plurality of distinct entities, and wherein the privacy criteria applied by the privacy filter is entity-specific such that different criteria corresponds to different individual entities.

10. The system of claim 1, wherein the notifier is to generate a plurality of distinct notification types corresponding to different destinations, and wherein the privacy criteria applied by the privacy filter is notification-type-specific such that different criteria corresponds to different destinations.

11. The system of claim 1, wherein the context assessor is to maintain a history log of location-specific stops by the subject and associated durations for those stops, and wherein the change impact assessor is to take into account the associated duration for a location at which the subject stops during the travel to the destination in its determination of the impact of any changes in the context indicia on the ETA.

12. The system of claim 1, wherein the system is incorporated as part of an autonomous vehicle.

13. A machine-implemented method for reporting activity of a subject, the method being executed autonomously by a computing device, and comprising:
generating context indicia relating to usage of the device based on sensor data and content data of the device, the usage of the device including travel to a destination;
determining an estimated time of arrival (ETA) of the subject at the destination based on the context indicia;
determining an impact of any changes in the context indicia on the ETA, wherein the ETA is to be updated based on the impact;
generating timeliness notification content to be included in a notification to an entity that is interested in arrival at the destination by the subject, wherein the timeliness notification content is generated based on a predefined degree of candor from among multiple degrees of candor regarding the timeliness of the ETA; and
applying privacy criteria that defines a content limit to the timeliness notification, wherein any content of the timeliness notification that exceeds the content limit is removed to produce a minimally-informative notification to be communicated to the entity.

14. At least one machine-readable medium containing instructions that, when executed on a computing device, cause the computing device to:
generate context indicia relating to usage of the device based on sensor data and content data of the device, the usage of the device including travel to a destination by a subject;
determine an estimated time of arrival (ETA) of the subject at the destination based on the context indicia;
determine an impact of any changes in the context indicia on the ETA, wherein the ETA is to be updated based on the impact;
generate timeliness notification content to be included in a notification to an entity that is interested in arrival at the destination by the subject, wherein the timeliness notification content is generated based on a predefined degree of candor from among multiple degrees of candor regarding the timeliness of the ETA; and
apply privacy criteria that defines a content limit to the timeliness notification, wherein any content of the timeliness notification that exceeds the content limit is removed to produce a minimally-informative notification to be communicated to the entity.

15. The at least one machine-readable medium of claim 14, further comprising instructions that, when executed, cause the computing device to automatically negotiate the degree of candor regarding the timeliness of the ETA to be provided in the timeliness notification with the entity.

16. The at least one machine-readable medium of claim 14, further comprising instructions that, when executed, cause the computing device to perform reinforcement-learning operations to improve accuracy of the context assessment over time.

17. The at least one machine-readable medium of claim 14, further comprising instructions that, when executed, cause the computing device to perform reinforcement-learning operations to improve accuracy of the change impact assessment over time.

18. The at least one machine-readable medium of claim 14, wherein the predefined degree of candor includes an indicator regarding timeliness of the subject relative to a scheduled time of arrival, but excludes current ETA information.

19. The at least one machine-readable medium of claim 14, wherein the predefined degree of candor includes an indicator regarding timeliness of the subject relative to a scheduled time of arrival, but excludes current location information.

20. The at least one machine-readable medium of claim 14, wherein the predefined degree of candor includes a stochastic indicator regarding timeliness of the subject relative to a scheduled time of arrival.

21. The at least one machine-readable medium of claim 14, wherein the privacy criteria are based on semantic analysis of textual substance of the notification.

22. The at least one machine-readable medium of claim 14, wherein the privacy criteria define criteria for assessing whether any of the content of the notification exceeds the predefined degree of candor regarding the timeliness of the ETA; and wherein the at least one machine-readable medium further comprises instructions that, when executed, cause the computing device to remove any of the content exceeding the predefined degree of candor.

23. The at least one machine-readable medium of claim 14, wherein the privacy criteria include a situational exception to the privacy criteria that permits content beyond the content limit to be included in the notification in response to context indicia that indicate an emergency situation.

24. The at least one machine-readable medium of claim 14, further comprising instructions that, when executed, cause the computing device to generate a plurality of distinct notification types corresponding to different individual entities interested in the arrival of the subject at the destination, wherein the privacy criteria are entity-specific such that different criteria are applicable to different ones of the individual entities.

25. The at least one machine-readable medium of claim 14, further comprising instructions that, when executed, cause the computing device to generate a plurality of distinct notification types corresponding to different destinations, and wherein the privacy criteria is notification-type-specific such that different criteria correspond to different destinations.
